(19) United States
(12) Patent Application Publication
(10) Pub. No.: US 2025/0181633 A1
(43) Pub. Date: Jun. 5, 2025

(54) SPECTRALSORT FRAMEWORK FOR SORTING IMAGE FRAMES

(71) Applicant: Google LLC, Mountain View, CA (US)

(72) Inventor: Dongeek Shin, San Jose, CA (US)

(21) Appl. No.: 18/844,027

(22) PCT Filed: Apr. 1, 2022
(86) PCT No.: PCT/US2022/071515

§ 371 Date: Sep. 4, 2024

(51) Int. Cl. G06F 16/538; G06F 16/535; G06F 16/56; G06F 16/583; G06T 7/90

(52) U.S. Cl. CPC G06F 16/538; G06F 16/535; G06F 16/56; G06F 16/5838; G06T 7/90; G06T 2207/10024; G06T 2207/20081

(57) ABSTRACT

A computing device is described that includes one or more processors configured to receive a search result set including a plurality of image frames, and determine, by a machine learning model of the computing device, one or more visual characteristics associated with each image frame of the plurality of image frames. The computing device is further configured to sort each image frame of the plurality of image frames based on the one or more visual characteristics of each image frame to generate an updated search result set.

### BACKGROUND

Many content providers, in response to a search request, provide a user interface (UI) component such as tabs or other display types for displaying search results. In many cases, each UI component may include a set of contents in a particular orientation, like horizontal or vertical. The content images can form a serial list of images that represent the search result, such as tile images, in no particular order with respect to visual aesthetics or impact on user experience.

### SUMMARY

In general, techniques of this disclosure are directed to the concept of physical aesthetic rearrangement of image frames based on visual characteristics using a computing system that includes a spectral analysis system. In one example, the spectral analysis system receives a search result for content that includes image frames, where each image frame has one or more visual characteristics, such as a color characteristic. The spectral analysis system includes a machine learning model trained to determine the one or more visual characteristics for each image frame. The spectral analysis system sorts each image frame based on the one or more visual characteristics and provides a set of sorted image frames without altering the content of the search results. As such, the techniques of this disclosure may optimize a visual experience for a user that initiated the search without sacrificing the usability of the search. For example, query parameters corresponding to action movies may return a set of image frames of cover art for action movies and their corresponding application pointers. The spectral analysis system may sort those image frames by the visual characteristic of color without adding or removing any of the application pointers related to the search for action movies.

In one example, this disclosure describes a method that includes receiving, by a computing device, a search result set including a plurality of image frames, determining, by a machine learning model of the computing device, one or more visual characteristics associated with each image frame of the plurality of image frames. The method further includes sorting, by the computing device, each image frame of the plurality of image frames based on the one or more visual characteristics of each image frame to generate an updated search result set.

In another example, a computing device includes a memory and one or more processors operably coupled to the memory and configured to receive a search result set including a plurality of image frames; apply a machine learning model configured to determine one or more visual characteristics associated with each image frame of the plurality of image frames; and sort each image frame of the plurality of image frames based on the one or more visual characteristics of each image frame to generate an updated search result set.

In another example, a computing device comprising means for performing a method that includes receiving, by a computing device, a search result set including a plurality of image frames, determining, by a machine learning model of the computing device, one or more visual characteristics associated with each image frame of the plurality of image frames. The method further includes sorting, by the computing device, each image frame of the plurality of image frames based on the one or more visual characteristics of each image frame to generate an updated search result set.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1A is a conceptual diagram illustrating an example computing system for sorting a search result for display, in accordance with one or more aspects of the present disclosure.

FIG. 1B depicts a conceptual diagram of an example machine-learned model included in a machine learning system, according to example implementations of the present disclosure.

FIG. 2 is a block diagram illustrating an example computing system for sorting a search result for display, in accordance with one or more aspects of the present disclosure.

FIG. 3 is a diagram illustrating an example of sorted content generated from queried content in accordance with one or more aspects of the present disclosure.

FIG. 4 is a conceptual diagram illustrating an example of a spectral sort of image frames, in accordance with one or more aspects of the present disclosure.

FIG. 5 is a flowchart illustrating an example mode of operation for a computing device to generate sorted image frames based on a search query, in accordance with one or more aspects of the present disclosure.

### DETAILED DESCRIPTION

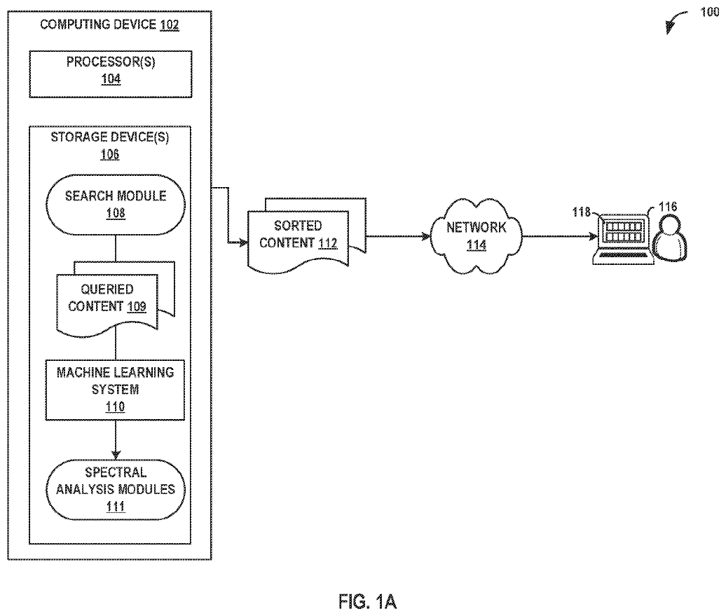

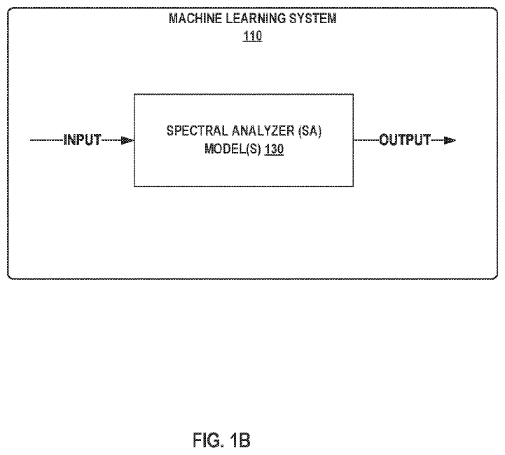

FIG. 1A is a conceptual diagram illustrating an example computer system 100 for sorting a search result for display, in accordance with one or more aspects of the present disclosure. The example computer system 100 of FIG. 1A includes computing device 102, network 114 and user device 116. Computing device 102 includes processor(s) 104 and storage device(s) 106 configured to store information, such as content and executable code associated with search module 108, machine learning system 110 and spectral analysis modules 111 within computing device 102 during operation.

Computing device 102 of computing system 100 may be implemented as any suitable computing system, such as one or more server computers, workstations, laptops, mainframes, appliances, cloud computing systems, smart phones, tablet computers, and/or other computing systems that may be capable of performing operations and/or functions described in accordance with one or more aspects of the present disclosure. In some examples, computing device 102 may represent a cloud computing system, server farm, and/or server cluster (or portion thereof) that provides services to client devices and other devices or systems, such as user device 116. In other examples, computing device 102 may represent or be implemented through one or more virtualized compute instances (e.g., virtual machines, containers, etc.) of a data center, cloud computing system, server farm, and/or server cluster. Components of computing device 102 may be distributed among one or more compute nodes, storage nodes, application nodes, web servers, or other computing devices.

One or more processors 104 may implement functionality and/or execute instructions within computing device 102. For example, one or more processors 104 may receive and execute instructions that provide the functionality of search module 108 and spectral analysis modules 111 to perform one or more operations as described herein. One or more processors 104 may include one or more processing units, such as a central processing unit (CPU), a digital signal processor (DSP), a general-purpose microprocessor, a tensor processing unit (TPU); a neural processing unit (NPU); a neural processing engine; a core of a CPU, VPU, GPU, TPU, NPU or other processing device, an application specific integrated circuit (ASIC), a field programmable logic array (FPGA), or other equivalent integrated or discrete logic circuitry, or other equivalent integrated or discrete logic circuitry.

In some examples, one or more storage devices of storage devices 106 may be a volatile or temporary memory. Examples of volatile memories include random access memories (RAM), dynamic random access memories (DRAM), static random access memories (SRAM), and other forms of volatile memories known in the art. Storage devices 106, in some examples, may also include one or more computer-readable storage media. Storage devices 106 may be configured to store larger amounts of information for longer terms in non-volatile memory than volatile memory. Examples of non-volatile memories include magnetic hard discs, optical discs, floppy discs, flash memories, or forms of electrically programmable memories (EPROM) or electrically erasable and programmable (EEPROM) memories. Storage devices 106 may store program instructions and/or data associated with search module 108 and spectral analysis modules 111.

User device 116 may be operated by a user. User device 116 may be implemented as any suitable client computing system, such as a mobile, non-mobile, wearable, and/or non-wearable computing device. User device 116 may represent a smart phone, a tablet computer, a computerized watch, a personal digital assistant, a virtual assistant, a gaming system, a media player, an e-book reader, a television or television platform, a laptop or notebook computer, a desktop computer, a camera, or any other type of wearable, non-wearable, mobile, or non-mobile computing device that may perform operations in accordance with one or more aspects of the present disclosure.

In one example, network 114 may include network hubs, network switches, network routers, etc., that are operatively inter-coupled to provide for the exchange of information between computing device 102 and user device 116. In some examples, communication links associated with network 114 may be wireless (e.g., Bluetooth®, 5G, Wi-Fi® etc.) and/or wired connections, Ethernet, asynchronous transfer mode (ATM) or other network connections.

One or more user devices (e.g., user device 116) may access functions and services provided by computing device 102 through network 114. For example, computing device 102 may be a content delivery service for delivering content to user device 116 for display by display 118. “Content” as used herein may include a representation of the content (e.g., digital tiles of movie posters, album covers, etc.) or the content itself (e.g., digital photos or other files). For example, a representation of the content may be image frames that include links or application pointers to other object files, such as movies, songs or albums associated with a search query.

In one example, computing device 102 may be an online provider of digital books, music, and movies. Computing device 102 may receive a query from user device 116 for science fiction books. In response, search module 108 may generate queried content 109, which may include a set of image frames of science fiction titles and book covers (e.g., image thumb nails) representing the underlying content of the search result. Each image frame may include one or more visual characteristics associated with its corresponding book cover, such as color, color intensity, and color distribution of the images representing each science fiction book within each corresponding image frame. The one or more visual characteristics may be associated with pixel data that includes, but is not limited to, pixel color values, pixel intensity values, and position values.

Machine learning system 110 may receive queried content 109 including pixel data for each image frame and determine a quantitative value for a visual characteristic of each image frame. As one example, the pixel data includes a numerical value for the color spectrum of each image frame for each book cover. Spectral analysis modules 111 may match the numerical values associated with each book cover to a defined spectrum of values in, for example, a color palette dictionary stored on storage devices 106. For example, machine learning system 110 determines a quantitative value for the color of each book cover (image frame), which is matched by the spectral analysis modules 111 against a color palette dictionary.

Spectral analysis modules 111 may sort the image frames according to the matched values to generate sorted content 112 for delivery to display 118 of user device 116. Spectral analysis modules 111 may sort each book cover according to the matched value, such as matched values ordered from darkest book cover colors, such as blues and blacks, to lightest colors, such as yellows and whites. In other examples, search module 108 may create one or more subsets of queried content 109, such as multiple rows of image frames, to sort based on one or more of 1) the size of queried content 109, 2) user interface design choice, or 3) type of search query.

In one example, queried content 109 is a static user interface (UI) frame including a multitude of image frames. A static UI frame is a set of image frames that are fixed in contrast to, for example, a row of scrollable image frames. The sorted content 112 may be another one or more static user interface frames where image frames within each static user interface frame are sorted according to one or more visual characteristics, such as color spectrum. As such, the updated search result set reflects only changes to the visual aspect of the displayed results within each static user interface frame without affecting the queried content.

FIG. 1B depicts a conceptual diagram of an example machine-learned model included in machine learning system 110, according to example implementations of the present disclosure. Machine learning system 110 may include one or more machine learned models such as spectral analyzer (SA) models 130. As illustrated in FIG. 1B, in some implementations, SA models 130 are trained to receive input data of one or more types and, in response, provide output data of one or more types. Thus, FIG. 1B illustrates SA models 130 performing inference.

The input data (e.g., image frame pixel data) may include one or more features, such as one or more visual characteristics, that are associated with an instance or example (e.g., image frame). In some implementations, the one or more features associated with the instance or example can be organized into a feature vector. In some implementations, the output data can include one or more predictions. Predictions can also be referred to as inferences. Thus, given features associated with a particular instance, SA models 130 can output a prediction for such instance based on the features. For example, a prediction of a color spectrum value based on one or more visual characteristics of the input image frame data.

SA models 130 can be or include one or more of various different types of machine-learned models. In particular, in some implementations, SA models 130 can perform classification, regression, clustering, anomaly detection, recommendation generation, and/or other tasks.

In some implementations, SA models 130 can perform various types of classification based on the input data. For example, SA models 130 can perform binary classification or multiclass classification. In binary classification, the output data can include a classification of the input data into one of two different classes. In multiclass classification, the output data can include a classification of the input data into one (or more) of more than two classes. The classifications can be single label or multi-label. SA models 130 may perform discrete categorical classification in which the input data is simply classified into one or more classes or categories.

In some implementations, SA models 130 can perform classification in which SA models 130 provides, for each of one or more classes, a numerical value descriptive of a degree to which it is believed that the input data should be classified into the corresponding class. In some instances, the numerical values provided by SA models 130 can be referred to as “confidence scores” that are indicative of a respective confidence associated with classification of the input into the respective class. In some implementations, the confidence scores can be compared to one or more thresholds to render a discrete categorical prediction. In some implementations, only a certain number of classes (e.g., one) with the relatively largest confidence scores can be selected to render a discrete categorical prediction.

SA models 130 may output a probabilistic classification. For example, SA models 130 may predict, given a sample input, a probability distribution over a set of classes. Thus, rather than outputting only the most likely class to which the sample input should belong, SA models 130 can output, for each class, a probability that the sample input belongs to such class. In some implementations, the probability distribution over all possible classes can sum to one. In some implementations, a Softmax function, or other type of function or layer can be used to squash a set of real values respectively associated with the possible classes to a set of real values in the range (0, 1) that sum to one.

In some examples, the probabilities provided by the probability distribution can be compared to one or more thresholds to render a discrete categorical prediction. In some implementations, only a certain number of classes (e.g., one) with the relatively largest predicted probability can be selected to render a discrete categorical prediction.

In cases in which SA models 130 performs classification. SA models 130 may be trained using supervised learning techniques. For example, SA models 130 may be trained on a training dataset that includes training examples labeled as belonging (or not belonging) to one or more classes. For example, SA models 130 may be trained with training datasets that include image frames including color spectrum labels that identify various colored areas within the image frame.

In some implementations, SA models 130 can perform regression to provide output data in the form of a continuous numeric value. The continuous numeric value can correspond to any number of different metrics or numeric representations, including, for example, currency values, scores, or other numeric representations. As examples, SA models 130 can perform linear regression, polynomial regression, or nonlinear regression. As examples, SA models 130 can perform simple regression or multiple regression. As described above, in some implementations, a Softmax function or other function or layer can be used to squash a set of real values respectively associated with two or more possible classes to a set of real values in the range (0, 1) that sum to one.

SA models 130 may perform various types of clustering. For example, SA models 130 can identify one or more previously-defined clusters to which the input data most likely corresponds. SA models 130 may identify one or more clusters within the input data. That is, in instances in which the input data includes multiple objects, documents, or other entities, SA models 130 can sort the multiple entities included in the input data into a number of clusters. In some implementations in which SA models 130 performs clustering, SA models 130 can be trained using unsupervised learning techniques.

SA models 130 may perform anomaly detection or outlier detection. For example, SA models 130 can identify input data that does not conform to an expected pattern or other characteristic (e.g., as previously observed from previous input data). As examples, the anomaly detection can be used for visual characteristic detection of input data such as image frame pixel data or other data types.

In some implementations, SA models 130 can provide output data in the form of one or more recommendations. For example, SA models 130 can be included in a recommendation system or engine. As an example, given input data that describes image frame data (e.g., pixel color values, pixel intensity values, and position values indicative of a color spectrum associated with each image frame), SA models 130 can output a color spectrum estimate that, based on the previous outcomes, is expected to have a desired outcome (e.g., determine a color spectrum match for each processed image frame for sorting in a UI frame to improve user experience metrics). As one example, given input data of image frames representing search query content, such as queried content 109 of FIG. 1A, a content provider, such as that represented by computing device 102 of FIG. 1A, can output sorted image frames (e.g., sorted content 112) representing the search query content based on of an application that may be visually pleasing to the user and increase user experience that may drive more traffic and business to the content provider system.

SA models 130 may, in some cases, act as an agent within an environment. For example, SA models 130 can be trained using reinforcement learning, which will be discussed in further detail below.

In some implementations, SA models 130 can be a parametric model while, in other implementations, SA models 130 can be a non-parametric model. In some implementations, SA models 130 can be a linear model while, in other implementations, SA models 130 can be a non-linear model.

As described above, SA models 130 can be or include one or more of various different types of machine-learned models. Examples of such different types of machine-learned models are provided below for illustration. One or more of the example models described below can be used (e.g., combined) to provide the output data in response to the input data. Additional models beyond the example models provided below can be used as well.

In some implementations, SA models 130 can be or include one or more classifier models such as, for example, linear classification models; quadratic classification models; etc. SA models 130 may be or include one or more regression models such as, for example, simple linear regression models; multiple linear regression models; logistic regression models; stepwise regression models; multivariate adaptive regression splines; locally estimated scatterplot smoothing models; etc.

In some examples, SA models 130 can be or include one or more decision tree-based models such as, for example, classification and/or regression trees; iterative dichotomiser 3 decision trees; C4.5 decision trees; chi-squared automatic interaction detection decision trees; decision stumps; conditional decision trees; etc.

SA models 130 may be or include one or more kernel machines. In some implementations, SA models 130 can be or include one or more support vector machines. SA models 130 may be or include one or more instance-based learning models such as, for example, learning vector quantization models; self-organizing map models; locally weighted learning models; etc. In some implementations, SA models 130 can be or include one or more nearest neighbor models such as, for example, k-nearest neighbor classifications models; k-nearest neighbors regression models; etc. SA models 130 can be or include one or more Bayesian models such as, for example, naïve Bayes models; Gaussian naïve Bayes models; multinomial naïve Bayes models; averaged one-dependence estimators; Bayesian networks; Bayesian belief networks; hidden Markov models; etc.

In some implementations, SA models 130 can be or include one or more artificial neural networks (also referred to simply as neural networks). A neural network can include a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

SA models 130 can be or include one or more feed forward neural networks. In feed forward networks, the connections between nodes do not form a cycle. For example, each connection can connect a node from an earlier layer to a node from a later layer.

In some instances, SA models 130 can be or include one or more recurrent neural networks. In some instances, at least some of the nodes of a recurrent neural network can form a cycle. Recurrent neural networks can be especially useful for processing input data that is sequential in nature. In particular, in some instances, a recurrent neural network can pass or retain information from a previous portion of the input data sequence to a subsequent portion of the input data sequence through the use of recurrent or directed cyclical node connections.

In some examples, sequential input data can include time-series data (e.g., sensor data versus time or imagery captured at different times). For example, a recurrent neural network can analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc.

Example recurrent neural networks include long short-term (LSTM) recurrent neural networks; gated recurrent units; bi-direction recurrent neural networks; continuous time recurrent neural networks; neural history compressors; echo state networks; Elman networks; Jordan networks; recursive neural networks; Hopfield networks; fully recurrent networks; sequence-to-sequence configurations; etc.

In some implementations, SA models 130 can be or include one or more convolutional neural networks. In some instances, a convolutional neural network can include one or more convolutional layers that perform convolutions over input data using learned filters. Filters can also be referred to as kernels. Convolutional neural networks can be especially useful for vision problems such as when the input data includes imagery such as still images (e.g., image frames) or video. However, convolutional neural networks can also be applied for natural language processing.

In some examples, SA models 130 can be or include one or more generative networks such as, for example, generative adversarial networks. Generative networks can be used to generate new data such as new images or other content.

SA models 130 may be or include an autoencoder. In some instances, the aim of an autoencoder is to learn a representation (e.g., a lower-dimensional encoding) for a set of data, typically for the purpose of dimensionality reduction. For example, in some instances, an autoencoder can seek to encode the input data and the provide output data that reconstructs the input data from the encoding. Recently, the autoencoder concept has become more widely used for learning generative models of data. In some instances, the autoencoder can include additional losses beyond reconstructing the input data.

SA models 130 may be or include one or more other forms of artificial neural networks such as, for example, deep Boltzmann machines; deep belief networks; stacked autoencoders; etc. Any of the neural networks described herein can be combined (e.g., stacked) to form more complex networks.

One or more neural networks can be used to provide an embedding based on the input data. For example, the embedding can be a representation of knowledge abstracted from the input data into one or more learned dimensions. In some instances, embeddings can be a useful source for identifying related entities. In some instances, embeddings can be extracted from the output of the network, while in other instances embeddings can be extracted from any hidden node or layer of the network (e.g., a close to final but not final layer of the network). Embeddings can be useful for performing auto suggest next video, product suggestion, entity, or object recognition, etc. In some instances, embeddings can be useful inputs for downstream models. For example, embeddings can be useful to generalize input data (e.g., search queries) for a downstream model or processing system.

SA models 130 may include one or more clustering models such as, for example, k-means clustering models; k-medians clustering models; expectation maximization models; hierarchical clustering models; etc.

In some implementations, SA models 130 can perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some implementations, SA models 130 can perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some implementations, SA models 130 can be an autoregressive model. In some instances, an autoregressive model can specify that the output data depends linearly on its own previous values and on a stochastic term. In some instances, an autoregressive model can take the form of a stochastic difference equation. One example of an autoregressive model is WaveNet, which is a generative model for raw audio.

In some implementations, SA models 130 can include or form part of a multiple model ensemble. As one example, bootstrap aggregating can be performed, which can also be referred to as “bagging.” In bootstrap aggregating, a training dataset is split into a number of subsets (e.g., through random sampling with replacement) and a plurality of models are respectively trained on the number of subsets. At inference time, respective outputs of the plurality of models can be combined (e.g., through averaging, voting, or other techniques) and used as the output of the ensemble.

One example ensemble is a random forest, which can also be referred to as a random decision forest. Random forests are an ensemble learning method for classification, regression, and other tasks. Random forests are generated by producing a plurality of decision trees at training time. In some instances, at inference time, the class that is the mode of the classes (classification) or the mean prediction (regression) of the individual trees can be used as the output of the forest. Random decision forests can correct for decision trees' tendency to overfit their training set.

Another example of an ensemble technique is stacking, which can, in some instances, be referred to as stacked generalization. Stacking includes training a combiner model to blend or otherwise combine the predictions of several other machine-learned models. Thus, a plurality of machine-learned models (e.g., of same or different type) can be trained based on training data. In addition, a combiner model can be trained to take the predictions from the other machine-learned models as inputs and, in response, produce a final inference or prediction. In some instances, a single-layer logistic regression model can be used as the combiner model.

Another example ensemble technique is boosting. Boosting can include incrementally building an ensemble by iteratively training weak models and then adding to a final strong model. For example, in some instances, each new model can be trained to emphasize the training examples that previous models misinterpreted (e.g., misclassified). For example, a weight associated with each of such misinterpreted examples can be increased. One common implementation of boosting is AdaBoost, which can also be referred to as Adaptive Boosting. Other example boosting techniques include LPBoost; TotalBoost; BrownBoost; xgboost; MadaBoost, LogitBoost, gradient boosting; etc. Furthermore, any of the models described above (e.g., regression models and artificial neural networks) can be combined to form an ensemble. As an example, an ensemble can include a top level machine-learned model or a heuristic function to combine and/or weight the outputs of the models that form the ensemble.

In some implementations, multiple machine-learned models (e.g., that form an ensemble can be linked and trained jointly (e.g., through backpropagation of errors sequentially through the model ensemble). However, in some implementations, only a subset (e.g., one) of the jointly trained models is used for inference.

In some implementations, SA models 130 can be used to preprocess the input data for subsequent input into another model. For example, SA models 130 can perform dimensionality reduction techniques and embeddings (e.g., matrix factorization, principal components analysis, singular value decomposition, word2vec/GLOVE, and/or related approaches), clustering, and even classification and regression for downstream consumption. Many of these techniques have been discussed above and will be further discussed below.

As discussed above, SA models 130 can be trained or otherwise configured to receive the input data and, in response, provide the output data. The input data can include different types, forms, or variations of input data. As examples, in various implementations, the input data can include features that describe the content (or portion of content) initially selected by the user, for example, content of user-selected document or image, links pointing to the user selection, links or image frames including links within the user selection relating to other files available on device or cloud, metadata of user selection, etc. Additionally, with user permission, the input data includes the context of user usage, either obtained from app itself or from other sources. Examples of usage context include breadth of share (sharing publicly, or with a large group, or privately, or a specific person), context of share, etc. When permitted by the user, additional input data can include the state of the device, e.g., the location of the device, the apps running on the device, etc.

In some implementations, SA models 130 can receive and use the input data in its raw form (e.g., image frame pixel data). In some implementations, the raw input data can be preprocessed. Thus, in addition or alternatively to the raw input data, SA models 130 can receive and use the preprocessed input data.

In some implementations, preprocessing the input data can include extracting one or more additional features from the raw input data. For example, feature extraction techniques can be applied to the input data to generate one or more new, additional features. Example feature extraction techniques include edge detection; corner detection; blob detection; ridge detection; scale-invariant feature transform; motion detection; optical flow; Hough transform; etc.

In some implementations, the extracted features can include or be derived from transformations of the input data into other domains and/or dimensions. As an example, the extracted features can include or be derived from transformations of the input data into the frequency domain. For example, wavelet transformations and/or fast Fourier transforms can be performed on the input data to generate additional features.

In some implementations, the extracted features can include statistics calculated from the input data or certain portions or dimensions of the input data. Example statistics include the mode, mean, maximum, minimum, or other metrics of the input data or portions thereof.

In some implementations, as described above, the input data can be sequential in nature. In some instances, the sequential input data can be generated by sampling or otherwise segmenting a stream of input data. As one example, frames can be extracted from a video. In some implementations, sequential data can be made non-sequential through summarization.

As another example of preprocessing technique, portions of the input data can be imputed. For example, additional synthetic input data can be generated through interpolation and/or extrapolation.

As another example of preprocessing technique, some or all of the input data can be scaled, standardized, normalized, generalized, and/or regularized. Example regularization techniques include ridge regression; least absolute shrinkage and selection operator (LASSO); elastic net; least-angle regression; cross-validation; L1 regularization; L2 regularization; etc. As one example, some or all of the input data can be normalized by subtracting the mean across a given dimension's feature values from each individual feature value and then dividing by the standard deviation or other metric.

As another example preprocessing technique, some or all or the input data can be quantized or discretized. In some cases, qualitative features or variables included in the input data can be converted to quantitative features or variables. For example, one hot encoding can be performed.

In some examples, dimensionality reduction techniques can be applied to the input data prior to input into SA models 130. Several examples of dimensionality reduction techniques are provided above, including, for example, principal component analysis; kernel principal component analysis; graph-based kernel principal component analysis; principal component regression; partial least squares regression; Sammon mapping; multidimensional scaling; projection pursuit, linear discriminant analysis; mixture discriminant analysis; quadratic discriminant analysis; generalized discriminant analysis; flexible discriminant analysis; autoencoding; etc.

In some implementations, during training, the input data can be intentionally deformed in any number of ways to increase model robustness, generalization, or other qualities. Example techniques to deform the input data include adding noise; changing color, shade, or hue; magnification; segmentation; amplification; etc.

In response to receipt of the input data, SA models 130 can provide the output data. The output data can include different types, forms, or variations of output data. As examples, in various implementations, the output data can include content, either stored locally on the user device or in the cloud, that is relevantly shareable along with the initial content selection.

As discussed above, in some implementations, the output data can include various types of classification data (e.g., binary classification, multiclass classification, single label, multi-label, discrete classification, regressive classification, probabilistic classification, etc.) or can include various types of regressive data (e.g., linear regression, polynomial regression, nonlinear regression, simple regression, multiple regression, etc.). In other instances, the output data can include clustering data, anomaly detection data, recommendation data, or any of the other forms of output data discussed above.

In some implementations, the output data can influence downstream processes or decision making. As one example, in some implementations, the output data can be interpreted and/or acted upon by a rules-based regulator.

The present disclosure provides systems and methods that include or otherwise leverage one or more machine-learned models to determine one or more visual characteristics associated with image frames (e.g., representing searchable content like movies) that may be used by a computing system to sort the image frames for display on a user device. The image frames and sorted image frames may be stored locally on the computing system or in the cloud or in combination thereof along with content associated with each image frame. Any of the different types or forms of input data described above can be combined with any of the different types or forms of machine-learned models described above to provide any of the different types or forms of output data described above.

The systems and methods of the present disclosure can be implemented by or otherwise executed on one or more computing devices (e.g., computing device 102). Example computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); server computing devices (e.g., database servers, parameter servers, file servers, mail servers, print servers, web servers, game servers, application servers, etc.); dedicated, specialized model processing or training devices; virtual computing devices; other computing devices or computing infrastructure; or combinations thereof.

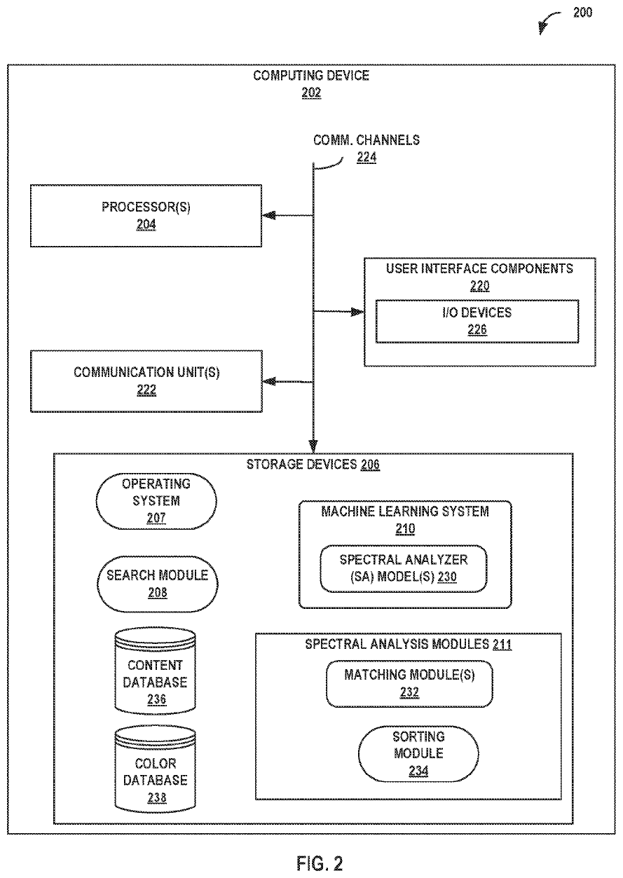

FIG. 2 is a block diagram illustrating an example computing system 200 for sorting a search result for display, in accordance with one or more aspects of the present disclosure. The computing system 200 of FIG. 2 illustrates one example of computing device 102, as illustrated in FIG. 1. As shown in the example of FIG. 2, computing device 202 includes one or more processors 204, one or more input/output components, such as user interface components (UIC) 220, one or more communication units 222, communication channels 224 and one or more storage devices 206. As shown in the example of FIG. 2, communication channels 224 may interconnect each of the components as shown for inter-component communications (physically, communicatively, and/or operatively). In some examples, communication channels 224 may include a system bus, a network connection (e.g., to a wireless connection as described above), one or more inter-process communication data structures, or any other components for communicating data between hardware and/or software locally or remotely. For example, connecting processors 204 to storage devices 206 for performing the functionality of various executable code stored in storage devices 206, such as operating system 207, search module 208, machine learning system 210, and spectral analysis modules 211.

User interface components 220 may include one or more I/O devices 226. I/O devices 226 of computing device 202 may receive inputs and generate outputs. Examples of inputs are tactile, audio, kinetic, and optical input, to name only a few examples. Input devices of I/O devices 226, in one example, may include a touchscreen, a touch pad, a mouse, a keyboard, a voice responsive system, a video camera, buttons, a control pad, a microphone or any other type of device for detecting input from a human or machine. Output devices of I/O devices 226, may include, a sound card, a video graphics adapter card, a speaker, a display, or any other type of device for generating output to a human or machine.

The one or more communication units 222 of computing device 202, for example, may communicate with external devices by transmitting and/or receiving data at computing device 202, such as to and from user device 116. Example communication units 222 include a network interface card (e.g., such as an Ethernet card), an optical transceiver, a radio frequency transceiver, or any other type of device that can send and/or receive information. Other examples of communication units 222 may be devices configured to transmit and receive Ultrawideband®, Bluetooth®), GPS, 3G, 4G, and Wi-Fi®, etc. that may be found in computing devices, such as mobile devices and the like.

Storage devices 206 of computing device 202 may include operating system 207, search module 208, machine learning system 210, spectral analysis modules 211, content database 236 and color database 238. Spectral analysis modules 111 may include one or more matching modules 232 and sorting module 234.

In one example, each spectral analyzer (SA) models 230 is a machine learned model as illustrated with respect to FIG. 1B. SA models 230 may be trained to determine one or more visual characteristics associated with each image frame associated with the queried content. In one example, computing device 202 receives a query for content stored in content database 236 through communication units 222 from a user device (e.g., user device 116). Search module 208 processes the query and generates queried content (e.g., queried content 109) based on content stored in content database 236. For example, a query from user device 116 may be for action movies. In response, search module 208 may generate queried content 109 that includes image frames, such as action movie poster tiles (movie tiles), representing a listing of action movies. Each movie tile may have a predominant color scheme, such as mostly reds, blues, etc. and are generated into a listing without any consideration of their respective color schemes.

In one example, to generate the image frames representing the queried content, search module 208 may apply a block-mode filtering scheme. A block-mode filtering scheme generates non-overlapping blocks of image frames based on a set of discrete user interface pages associated with the queried content. As such, the search result is maintained while permitting each image frame to be processed and sorted by machine learning system 110 and spectral analysis modules 111 to achieve, for example, user experience metrics that balance search result usability and visual aesthetics that does not over emphasize one over the other.

The image frames corresponding to the movie tiles may be provided as input to machine learning system 210, which includes one or more SA models 230. In one example, the SA models 230 are trained machined learned models that determine a spectral embedding, such as a 3-channel spectral embedding, that represents a color spectrum for each image frame based on pixel data that represents each image frame in a two-dimensional (2D) red-green-blue (RGB) array format. Thus, the output of SA models 230 is a spectral embedding value that is associated with each movie tile color scheme.

Matching modules 232 may determine a color vector index value for each image frame based on comparing the spectral embedding to a set of color vector index values stored in color database 238. The set of color vector index values in color database 238 may represent, for example, a color palette dictionary where each color vector index value may correspond to a numerical representation of a particular color spectrum, such red, brown, green, etc. In one example, matching modules 232 compares a Euclidean distance between each spectral embedding against a set of color vector index values stored in color database 238. Matching modules 232 may select a color vector index value that has a minimal Euclidean distance between the spectral embedding and the color vector index value. Thus, each movie tile (image frame) will have a color vector index value based on their respective predominant movie poster colors.

Sorting module 234 may sort or arrange each movie tile (image frame of the plurality of image frames) based on the selected color vector index values to generate sorted content (e.g., sorted content 112). In this example, a listing of movie tiles in a predefined color spectral order that may be aesthetically pleasing to a user, such as darkest to lightest colors, etc. For example, a color index value of 1 may be black, a value of 10 may be blue, a value of 20 may be green, a value of 30 may be red and so on. In one example, sorting the selected color index values may be in ascending order (lowest to highest) or, in other examples, descending order or other by another sorting technique. The color database 238 may store a multitude of color palette preferences where each color palette has a different set of color vector index values such that when sorted present a specific color palette. For example, a color palette based on a rainbow order of colors values or cool to warm order of color values, etc. In one example, computing device 202 may receive a color palette preference from a user device and correspondingly select a color palette dictionary from a plurality of color palette dictionaries stored in color database 238.

In one example, communication units 222 of computing device 202 may provide the sorted movie tiles (e.g., sorted content 112) to a user device for display (e.g., user device 116, display 118) over a network (e.g., network 114). In examples, the sorted content provided to the user device includes one or more static user interface frames, where each user interface frame for display on the user device includes sorted images frames.

One or more of spectral analysis modules 111 may perform operations described herein using software, hardware, firmware, or a mixture of both hardware, software, and firmware residing in and executing on computing device 202 or at one or more other remote computing devices (e.g., cloud-based application—not shown). Computing device 202 may execute machine learning system 210, spectral analysis modules 211 including matching modules 232 and sorting module 234, with one or more processors 204, or may execute any or part of machine learning system 210 and spectral analysis modules 211 as or within a virtual machine executing on underlying hardware. One or more of machine learning system 210 and spectral analysis modules 211 may be implemented in various ways, for example, as a downloadable or pre-installed application, remotely as a cloud application or as part of operating system 207 of computing device 202. Other examples of computing device 202 that implement techniques of this disclosure may include additional components not shown in FIG. 1 or 2.

In the examples of FIGS. 1 and 2, one or more processors 204 may implement functionality and/or execute instructions within computing device 102 and 202. For example, one or more processors 204 may receive and execute instructions that provide the functionality of user interface components 220, communication units 222, one or more storage devices 206 and operating system 207 to perform one or more operations as described herein.

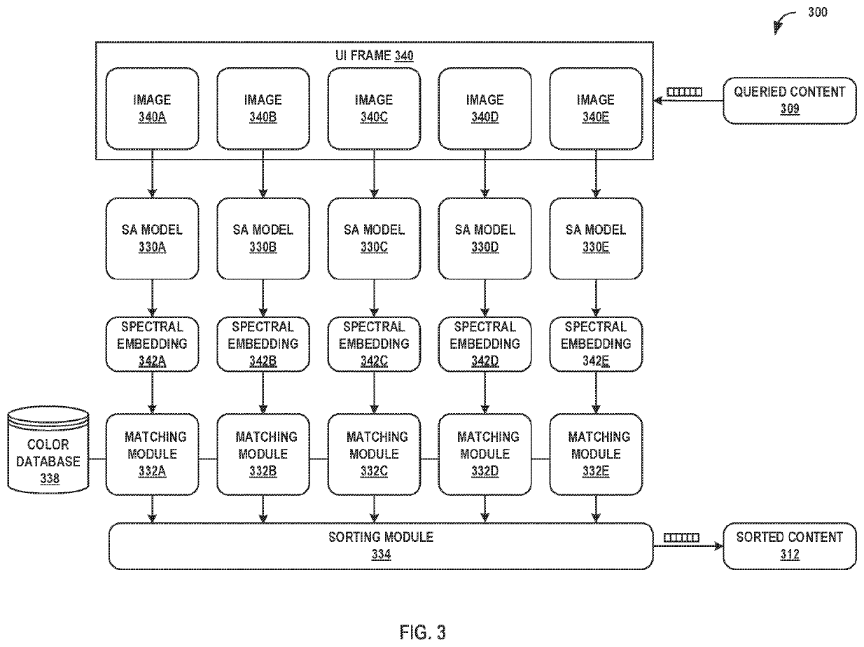

FIG. 3 is a diagram illustrating an example of sorted content generated from queried content in accordance with one or more aspects of the present disclosure. FIG. 3 is described below in the context of computing device 102 and 202 of FIGS. 1 and 2. For example, machine learning system 110 and spectral analysis modules 111 of computing device 102 of FIG. 1 may receive queried content 309 that includes image frames 340A-E of user interface (UI) frame 340 for generating sorted content 312. In other examples, spectral analysis modules 111 may be implemented by user device 116 and user device 116 may receive queried content 309 for generating sorted content 312.

In the example of FIG. 3, image frames 340A-E of UI frame 340 are operated upon in parallel to generate sorted content 312. Each image frame is received and operated upon by instances of SA model 330 and matching module 332, in this example, SA models 330A-E and matching modules 332A-E. For example, SA model 330A receives image frame 340A to generate spectral embedding 342A. Matching module 332A receives spectral embedding 342A and, as described above with respect to FIG. 3, matching module 332A may determine a color vector index value (not shown) for each image frame based on comparing the spectral embedding to a set of color vector index values stored in color database 238. Image frames 340B-E are operated upon to determine their respective color vector index value using SA model 330B-E, spectral embedding 342B-E, and match modules 332B-E. Sorting module 334 may receive each color vector index value for each image frame 340A-E from matching modules 332A-E and sort each image frame based on the selected color vector index values to generate sorted content 312.

In other examples, each image frame of UI frame 340 may be operated upon serially or a combination of serial with parallel to generate sorted content 312. In examples where a serial architecture is implemented, prior to sorting by sorting module 334, spectral analysis modules 111 (e.g., matching module 332) may store or buffer (e.g., in storage devices 106) determined color vector index values for each image frame until each image frame 340A-E has a determined color vector index value. Sorting module 334 may sort each image frame based on the selected color vector index values to generate sorted content 312. In another example, sorting module 334 may iteratively sort each image frame as each respective color vector index value is generated until an indication is received to stop sorting, such as a last image frame indicator or a threshold has been met (e.g., max image frame count).

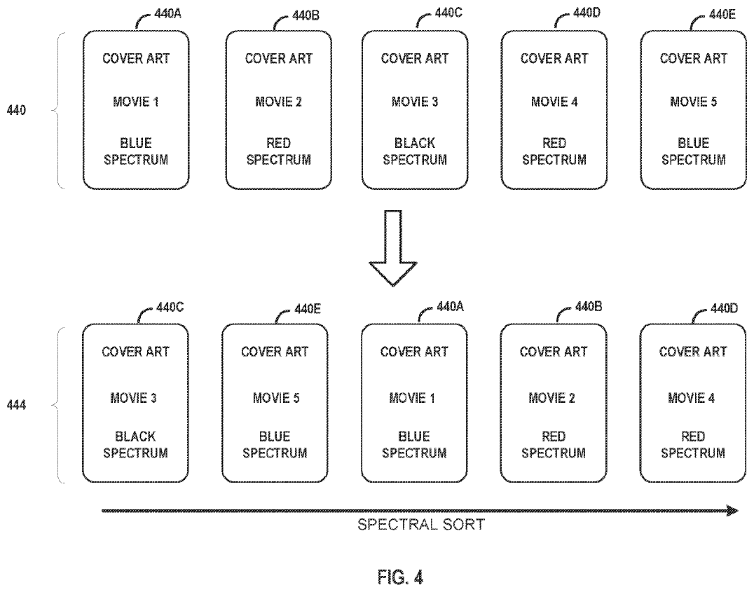

FIG. 4 is a conceptual diagram illustrating an example of a spectral sort of image frames, in accordance with one or more aspects of the present disclosure. For simplicity, FIG. 4 will be discussed with reference to the operation of FIGS. 1, 2 and 3. In one example, image frame set 440 (e.g., a static UI frame) is an example result of a query for movies that returned content (e.g., movie poster tiles) in no particular visual order. For example, the query result may be queried content 109 returned by search module 108 in response to a query from user device 116.

As illustrated in image frame set 440, image frames are ordered 440A through 440E from left to right, where image frame 440A is an image frame having visual characteristics (e.g., pixel color and intensity values) in the blue spectrum, image frame 440B red spectrum, image frame 440C black spectrum, image frame 440D red spectrum, and image frame 440E blue spectrum. The colors illustrated are by example only, the image frames may contain a multitude of colors and one or more color spectrums may make up a majority of an image frame. For example, an image frame 440A and E may represent a movie about ocean life that is primarily cool colors such as blue and green hues. Image frames 440B and D may represent a movie about volcanoes and consist primarily of warm colors such as red and yellow hues, while image frame 440C may represent a movie about space travel and consist primarily of dark colors such as black and grey hues. In that order in a user interface, image frame 440A, image frame 440B, and image frame 440C may visually present a harsh contrast of colors and be visually unappealing to a user.

Thus, in one example, to enhance user visual experience, machine learning system 210 and spectral analysis modules 211 may process the image frames of queried content 109 (as discussed in FIGS. 1 and 2) to generate sorted content 112, as illustrated by image frame set 444. As described above with reference to FIG. 2, spectral analysis modules 211 may receive the color embedding (vector) output of machine learning system 210 and perform a matching function and spectral sort on the results.

In this example of a matching function, spectral analysis modules 211 matches the color embedding for each image frame to a color index value in a color palette dictionary that defines a color index value of 1 is black, a value of 10 blue, a value of 20 green, and a value of 30 red. From left to right, the image frame set 444 displays image frame 440C representing the space travel movie tile in the black spectrum, image frame 440E and 440A representing the ocean life movies in the blue spectrum, and image frames 440B and D representing the volcano movies in the red spectrum. Thus, image frame set 444 includes the same queried content of movie poster tiles as the queried content of image frame set 440 but in a color spectral order as defined by the color palette dictionary. In other examples, the color spectral sort may be a selectable color palette dictionary stored in color database 238. For example, the spectral sort may be based on a color palette dictionary of a rainbow spectrum: red, orange, yellow, green, blue, indigo, and violet.

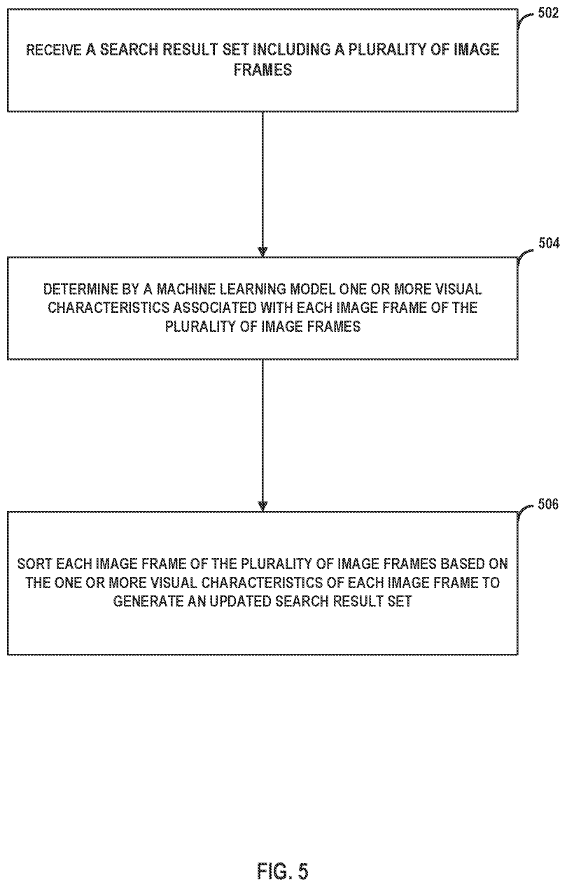

FIG. 5 is a flowchart illustrating an example mode of operation for a computing device to generate sorted image frames based on a search query, in accordance with one or more aspects of the present disclosure. FIG. 5 is described below in the context of computing device 102 and 202 of FIGS. 1 and 2. As shown in FIG. 5, computing device 202, for example, may receive a query including query parameters from a user device (e.g., user device 116) for content accessible by computing device 202. In response, search module 208 may generate queried content including a search result. Computing device 202 may receive the search result set that includes a plurality of image frames (502). Computing device 202 may include a machine learning system 210 and spectral analysis modules 211. The machine learning system 110 may include SA models 230 that determines one or more visual characteristics associated with each image frame of the plurality of image frames (504).

Sorting module 234 of computing device 202 may sort each image frame of the plurality of image frames based on the one or more visual characteristics of each image frame to generate an updated search result set (506). In one example, a color vector index value is determined for each image frame based on the respective one or more visual characteristics and sorting module 234 sorts each image based on the color vector index value to generate sorted content including the updated search result set.

This disclosure includes the following examples.

Example 1: A method comprising receiving, by a computing system, a search result set including a plurality of image frames; determining, by a machine learning model of the computing system, one or more visual characteristics associated with each image frame of the plurality of image frames; and sorting, by the computing system, each image frame of the plurality of image frames based on the one or more visual characteristics of each image frame to generate an updated search result set.

Example 2: The method of example 1, wherein determining one or more visual characteristics comprises determining, from pixel data from each image frame and using the machine learning model, a spectral embedding that represents a color spectrum for each image frame; and determining a color vector index value for each image frame based on the spectral embedding.

Example 3: The method of any one of examples 1-2, wherein determining the color vector index value for each image frame comprises comparing, by the computing system, a Euclidean distance between each spectral embedding against each color vector index value of a color palette dictionary of color vector index values; and selecting a color vector index value having a minimal Euclidean distance between the spectral embedding and the color vector index value.

Example 4: The method of any one of examples 2-3, wherein, prior to comparing the Euclidean distance between each spectral embedding against each color vector index value of a color palette dictionary, the method further comprises receiving, by the computing system, a color palette preference; and selecting the color palette dictionary from a plurality of color palette dictionaries based on the color palette preference.

Example 5: The method of any one of examples 2-4, wherein each color vector index value of each image frame is represented by a numerical value and wherein sorting each image frame of the plurality of image frames further comprises sorting each image frame of the plurality of image frames from based on the value of each color vector index value.

Example 6: The method of any one of examples 1-5, wherein the search result set is a subset of search result data sorted based on one or more query parameters.

Example 7; The method of example 6, wherein the search result set is one of a plurality of search result sets that are subsets of the search result data, each of the plurality of search result sets including a plurality of image frames, and wherein receiving the search result set comprises receiving each of the plurality of search result sets to sort based on the one or more visual characteristics of each image frame in each search result set.

Example 8: The method of example 7, further comprising generating, by the computing system, a user interface including a row of images corresponding to each updated search result set.

Example 9: The method of any one of examples 1-8, further comprising generating, by the computing system, a static user interface including a row of images corresponding to the updated search result set.

Example 10: The method of any one of examples 1-9, wherein determining one or more visual characteristics comprises determining, by the computing system, from pixel data for each image frame a color space for each image frame, wherein the pixel data for each pixel includes color, intensity, and position.

Example 11: A computing device comprising a memory; and one or more processors operably coupled to the memory and configured to receive a search result set including a plurality of image frames; apply a machine learning model configured to determine one or more visual characteristics associated with each image frame of the plurality of image frames; and sort each image frame of the plurality of image frames based on the one or more visual characteristics of each image frame to generate an updated search result set.

Example 12: The computing device of example 11, wherein to determine one or more visual characteristics, the machine learning model further configured to determine, from pixel data from each image frame, a spectral embedding that represents a color spectrum for each image frame; and wherein the one or more processors are further configured to determine a color vector index value for each image frame based on the spectral embedding.

Example 13: The computing device of any one of examples 11-12, wherein to determine the color vector index value for each image frame, the one or more processors are further configured to compare a Euclidean distance between each spectral embedding against each color vector index value of a color palette dictionary of color vector index values; and select a color vector index value having a minimal Euclidean distance between the spectral embedding and the color vector index value.

Example 14: The computing device of any one of examples 12-13, wherein each color vector index value of each image frame is represented by a numerical value, and wherein to sort each image frame of the plurality of image frame, the one or more processors are further configured to sort each image frame of the plurality of image frames from based on the numerical value of each image frame.

Example 15: A non-transitory computer-readable storage medium storing instructions that, when executed, cause one or more processors of a computing device to perform any of the methods of examples 1-10.

In another example, a computing system comprising means for XXX

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

Various examples of the invention have been described. These and other examples are within the scope of the following claims.

1. A method comprising:
receiving, by a computing system, a search result set including a plurality of image frames;
determining, by a machine learning model of the computing system, one or more visual characteristics associated with each image frame of the plurality of image frames; and
sorting, by the computing system, each image frame of the plurality of image frames based on the one or more visual characteristics of each image frame to generate an updated search result set.

2. The method of claim 1, wherein determining the one or more visual characteristics comprises:
determining, from pixel data from each image frame and using the machine learning model, a spectral embedding that represents a color spectrum for each image frame; and
determining a color vector index value for each image frame based on the spectral embedding.

3. The method of claim 2, wherein determining the color vector index value for each image frame comprises:
comparing, by the computing system, a Euclidean distance between each spectral embedding against each color vector index value of a color palette dictionary of color vector index values; and
selecting a color vector index value having a minimal Euclidean distance between the spectral embedding and the color vector index value.

4. The method of claim 3, wherein, prior to comparing the Euclidean distance between each spectral embedding against each color vector index value of a color palette dictionary, the method further comprises:
receiving, by the computing system, a color palette preference; and
selecting the color palette dictionary from a plurality of color palette dictionaries based on the color palette preference.

5. The method of claim 3, wherein each color vector index value of each image frame is represented by a numerical value and wherein sorting each image frame of the plurality of image frames further comprises:
sorting each image frame of the plurality of image frames from based on the value of each color vector index value.

6. The method of claim 1, wherein the search result set is a subset of search result data sorted based on one or more query parameters.

7. The method of claim 6, wherein the search result set is one of a plurality of search result sets that are subsets of the search result data, each of the plurality of search result sets including a plurality of image frames, and
wherein receiving the search result set comprises receiving each of the plurality of search result sets to sort based on the one or more visual characteristics of each image frame in each search result set.

8. The method of claim 7, further comprising generating, by the computing system, a user interface including a row of images corresponding to each updated search result set.

9. The method of claim 1, further comprising generating, by the computing system, a static user interface including a row of images corresponding to the updated search result set.

10. The method of claim 1, wherein determining one or more visual characteristics comprises:
determining, by the computing system, from pixel data for each image frame a color space for each image frame, wherein the pixel data for each pixel includes color, intensity, and position.

11. A computing device comprising:
a memory; and
one or more processors operably coupled to the memory and configured to:
receive a search result set including a plurality of image frames;
apply a machine learning model configured to determine one or more visual characteristics associated with each image frame of the plurality of image frames; and
sort each image frame of the plurality of image frames based on the one or more visual characteristics of each image frame to generate an updated search result set.

12. The computing device of claim 11,
wherein to determine the one or more visual characteristics, the machine learning model further configured to determine, from pixel data from each image frame, a spectral embedding that represents a color spectrum for each image frame, and
wherein to determine the one or more visual characteristics, the one or more processors are further configured to determine a color vector index value for each image frame based on the spectral embedding.

13. The computing device of claim 12, wherein to determine the color vector index value for each image frame, the one or more processors are further configured to:
compare a Euclidean distance between each spectral embedding against each color vector index value of a color palette dictionary of color vector index values; and
select a color vector index value having a minimal Euclidean distance between the spectral embedding and the color vector index value.

14. The computing device of claim 13, wherein each color vector index value of each image frame is represented by a numerical value, and wherein to sort each image frame of the plurality of image frame, the one or more processors are further configured to:
sort each image frame of the plurality of image frames from based on the numerical value of each image frame.

15. A non-transitory computer-readable storage medium storing instructions that, when executed, cause one or more processors of a computing device to:
receive a search result set including a plurality of image frames;
determine, by applying a machine learning model, one or more visual characteristics associated with each image frame of the plurality of image frames; and
sort each image frame of the plurality of image frames based on the one or more visual characteristics of each image frame to generate an updated search result set.

16. The non-transitory computer-readable storage medium of claim 15, wherein to determine one or more visual characteristics, the instructions cause the one or more processors to:
determine, from pixel data from each image frame and using the machine learning model, a spectral embedding that represents a color spectrum for each image frame, and
wherein the instructions further cause the one or more processors to determine a color vector index value for each image frame based on the spectral embedding.

17. The non-transitory computer-readable storage medium of claim 16, wherein to determine the color vector index value for each image frame, the instructions further cause the one or more processors to:
compare a Euclidean distance between each spectral embedding against each color vector index value of a color palette dictionary of color vector index values; and
select a color vector index value having a minimal Euclidean distance between the spectral embedding and the color vector index value.

18. The non-transitory computer-readable storage medium of claim 17,
wherein each color vector index value of each image frame is represented by a numerical value, and
wherein to sort each image frame of the plurality of image frame, the instructions further cause the one or more processors to sort each image frame of the plurality of image frames from based on the numerical value of each image frame.

19. The non-transitory computer-readable storage medium of claim 15, wherein the search result set is a subset of search result data sorted based on one or more query parameters.

20. The non-transitory computer-readable storage medium of claim 19, wherein the search result set is one of a plurality of search result sets that are subsets of the search result data, each of the plurality of search result sets including a plurality of image frames, and
wherein to receive the search result, the instructions further cause the one or more processors to receive each of the plurality of search result sets to sort based on the one or more visual characteristics of each image frame in each search result set.
